(19) United States
(12) Patent Application Publication
(10) Pub. No.: US 2014/0143672 A1
(43) Pub. Date: May 22, 2014

(54) SYSTEM AND METHOD FOR FUNCTION EXPANDABLE COLLABORATION SCREEN SYSTEM

(71) Applicant: Electronics and Telecommunications Research Institute, Daejeon (KR)

(72) Inventors: Min-Jung KIM, Daejeon (KR); Moon-Soo LEE, Daejeon (KR); Seung-Joon KWON, Seoul (KR); Sun-Joong KIM, Daejeon (KR); Kee-Seong CHO, Daejeon (KR); Won RYU, Daejeon (KR)

(73) Assignee: Electronics and Telecommunications Research Institute, Daejeon (KR)

(21) Appl. No.: 13/899,943

(22) Filed: May 22, 2013

(30) Foreign Application Priority Data
Nov. 21, 2012 (KR) 10-2012-0132408

(51) Int. Cl. G06F 3/0483

(52) U.S. Cl. CPC G06F 3/0483
USPC 715/733

(57) ABSTRACT

Provided are a function expandable collaboration screen apparatus and method by freely adding or moving web apps to a collaboration screen including a variety of contents according to a collaboration purpose. The function expandable collaboration screen system according to the present invention includes a collaboration screen apparatus configured to generate a collaboration container on the basis of received collaboration content and collaboration content information and add a web application to the received collaboration content to perform sharing and collaboration works, and a collaboration client configured to select the collaboration content, deliver the selected collaboration content and collaboration content information, remotely connect to the collaboration screen apparatus to remotely control the collaboration content, and update a screen on the basis of the received content change.

### CROSS-REFERENCE TO RELATED APPLICATION

This application claims the benefit under 35 U.S.C. §119(a) of a Korean Patent Application No. 10-2012-0132408, filed on Nov. 21, 2012, the entire disclosure of which is incorporated herein by reference for all purposes.

### BACKGROUND

1. Field

The following description relates to a collaboration screen including a variety of contents, and more particularly, to a collaboration screen apparatus and method for expanding functions by dynamically adding operable web applications onto the collaboration screen.

2. Description of the Related Art

In the past, collaboration was performed only in an off-line space and inefficient in that it had a lot of limitations in distance and time. With the development of networking technologies, however, the current trend is to perform collaboration in an on-line space as well as an off-line space.

The most representative technology for collaboration is a screen-sharing-based collaboration technology using a remote desktop protocol (RDP). The RDP is driven by allowing several users who want to establish a connection to receive screen information containing media stream of the same screen and by sending and processing a message about control to a shared screen. In case of adding a specific application onto a collaboration screen using a streaming-based collaboration technology, the specific application is installed in a host PC, and clients connecting to the host PC may perform collaboration without installing the specific application because the clients share the screen with one another. However, with the technology, the collaboration screen continuously transmits data including a compressed screen image to a receiving side. This may result in significant delay during transmission and reception processes and increase an amount of traffic in proportion to the number of user terminals. Thus, this technology may be only used in collaboration between a few local users.

Compared to a streaming-based screen sharing program, a web board technology may induce a relatively little traffic in collaboration between multiple users and enable web-server-based content sharing and co-working. The web-board-based collaboration technology prepares for a separate space for collaboration on a web server, shares a web page, a video, a picture, a document, etc., and allows multiple users to simultaneously edit the shared content on the web board. This technology presents a collaboration method that enables real-time communication between participants connecting to the web board and allows the participants to share a web page storing a work result with each other. However, the web-board-based collaboration technology has a limitation of allowing respective clients to share common data established in a web server and thus providing a fixed collaboration environment. That is, in order to add a specific function onto a web board, a web server program may be entirely modified to expand functions.

For a collaboration screen with a cloud-based virtualization technology, collaboration may be performed by remotely using an application installed in a server or sharing documents or multimedia content stored in cloud storage. However, this collaboration is just for resource sharing, and several users can not freely add or move an application to a collaboration screen according to the purpose of collaboration, that is, dynamic expansion of functions is not allowed.

A web app is a computer software that is coded in a programming language such as HTML, CSS, JavaScript, etc. and reliant on a common web browser to render the application executable. The web app is created to perform a specific function such as display of remote data, but evolves to process interactions of a variety of users, as similar to general applications. In particular, a widget can be downloaded to clients in a package form and then installed and executed. However, most web apps can be executed only independently, but cannot have been used for collaboration.

Korean Patent Application No. 10-2010-0123562 discloses a collaboration server for sharing in real time a video, a picture, a document, etc. and providing multiple tasking such that several users may work simultaneously, by sharing a screen on-line. However, this does not allow expansion of function but on-line sharing of display.

### SUMMARY

The present invention provides a function expandable collaboration screen apparatus and method by freely adding or moving web apps onto a collaboration screen including a variety of contents according to a collaboration purpose.

In one general aspect, the function expandable collaboration screen system includes: a collaboration screen apparatus configured to generate a collaboration container on the basis of received collaboration content and collaboration content information, allocate a control right for the collaboration container, convert the received collaboration content to insert the converted collaboration content into the collaboration container to perform sharing and collaboration works, and deliver a content change occurring in the collaboration content of the collaboration container; and a collaboration client configured to select collaboration content, deliver the selected collaboration content and collaboration content information, remotely connect to the collaboration screen apparatus to remotely control the collaboration content, and update a screen on the basis the received content change.

In another general aspect, the collaboration screen apparatus includes: a content conversion unit configured to classify received collaboration content on the basis of the type thereof and convert the received collaboration content such that a web application is inserted into the received collaboration content; a web app management unit configured to store a plurality of web applications and deliver the stored web application upon a request; and a collaboration page unit configured to execute the converted collaboration content to generate one or more collaboration containers that are shared with one or more other users, and add to the converted collaboration content the web application received from the web app management unit to expand functions thereof.

In still another general aspect, the content collaboration method of the function expandable collaboration screen system selects collaboration content for performing collaboration work and searches for and selects a collaboration screen apparatus for sharing the collaboration content. Depending on a result, the method transmits the collaboration content and collaboration content information to the selected collaboration screen apparatus and generates the collaboration container for sharing the collaboration content. Next, the method converts the collaboration content to insert the converted collaboration content into the collaboration container and shares the collaboration container including the converted collaboration content with one or more collaboration clients.

Other features and aspects will be apparent from the following detailed description, the drawings, and the claims.

### BRIEF DESCRIPTION OF THE DRAWINGS

FIG. 1 is a block diagram showing a function expandable collaboration screen system according to the present invention.

FIG. 2 is a block diagram showing a collaboration screen apparatus of the function expandable collaboration screen system according to the present invention.

FIG. 3 is a block diagram showing a collaboration client of the function expandable collaboration screen system according to the present invention.

FIG. 4 is a flowchart illustrating a method of moving collaboration content of the function expandable collaboration screen system according to an embodiment of the present invention.

FIG. 5 is a flowchart illustrating a method of sharing collaboration content of the function expandable collaboration screen system according to an embodiment of the present invention.

FIG. 6 is a flowchart illustrating a method of acquiring a control right for controlling collaboration content of the function expandable collaboration screen system according to an embodiment of the present invention.

FIG. 7 is a flowchart illustrating a method of transmitting content, which enables information extraction on the basis of a type of collaboration content according to an embodiment of the present invention.

FIG. 8 is a flowchart illustrating a method of receiving collaboration content according to an embodiment of the present invention.

FIG. 9a illustrates a configuration of collaboration content information of web-page-based content according to an embodiment of the present invention.

FIG. 9b illustrates a configuration of collaboration content information of local-file-based content according to an embodiment of the present invention.

FIG. 9c illustrates a configuration of collaboration content information of a web app according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, embodiments of the present invention will be described in detail with reference to the accompanying drawings. Terms used herein are terms that have been selected in consideration of functions and effects in embodiments, and the meanings of the terms may be altered according to the intent of a user or operator, or conventional practice. Therefore, the meanings of terms used in the below-described embodiments confirm to definitions when defined specifically in the specification, but when there is no detailed definition, the terms should be construed as meanings known to those skilled in the art.

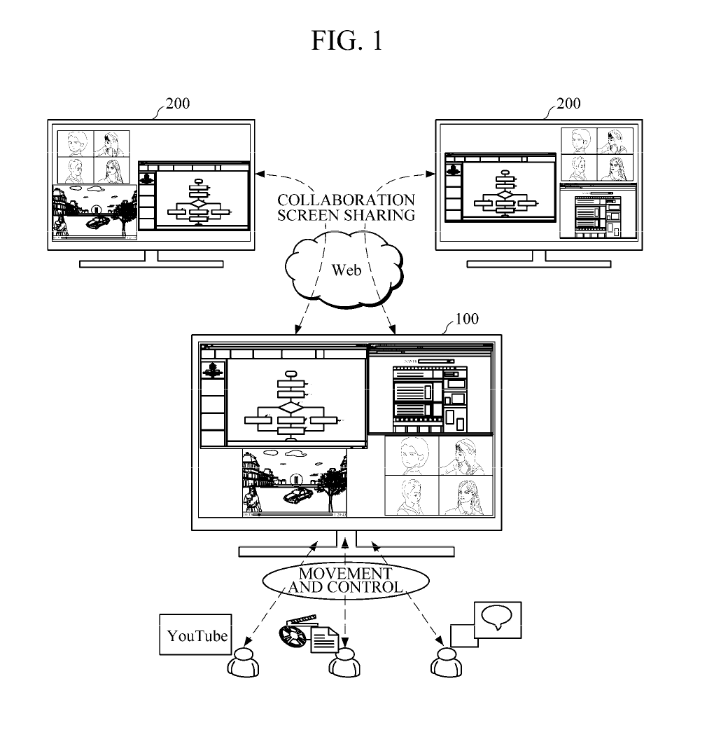

FIG. 1 is a block diagram showing a function expandable collaboration screen system according to the present invention.

Referring to FIG. 1, the collaboration screen system includes a collaboration screen apparatus 100 and one or more collaboration clients 200.

The collaboration screen apparatus 100 is a screen space that is connected by multiple users to share their variety of contents and perform a collaboration work for a specific purpose. The collaboration screen apparatus 100 may be developed as a separate application program or an HTML based web page operable on a web browser. The content used in the collaboration screen apparatus 100 may be a user's own document, video, and image and include a web page or web video operable on the web. Also, the content may be an application such as a web-based operable web app. The collaboration screen apparatus 100 may be established locally or in a remote server, but is not limited thereto.

Each collaboration client 200 connects to the collaboration screen apparatus 100 to communicate data with the collaboration screen apparatus 100, i.e., to perform collaboration. Also, the collaboration client 200 may connect to the collaboration screen apparatus 100 through a relay server or directly in a local area communication system such as near field communication (NFC) or WiFi Direct.

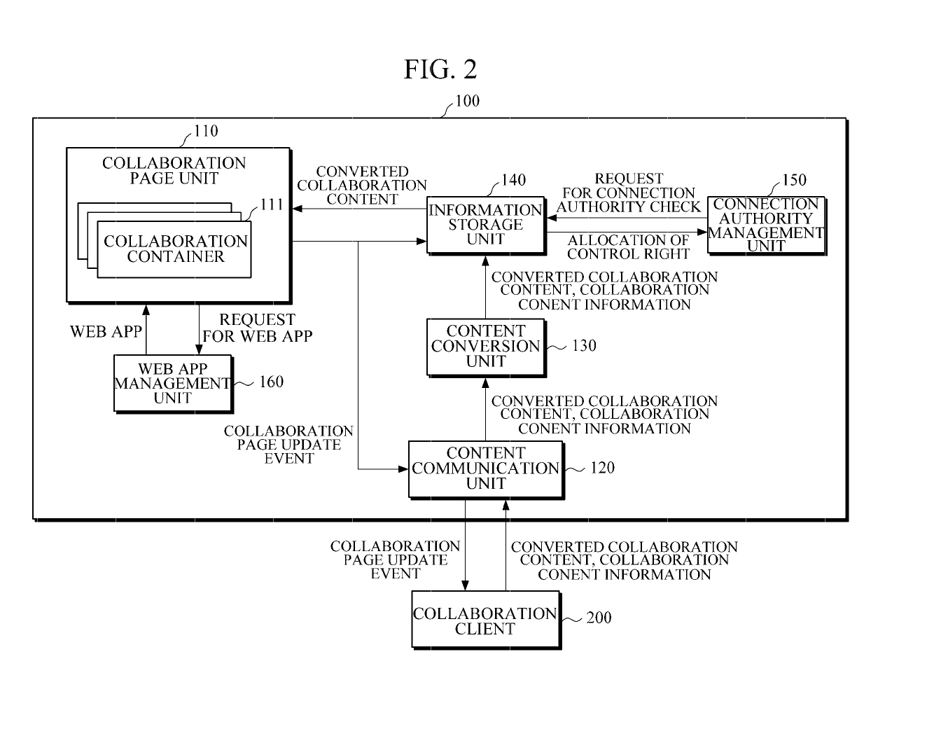

FIG. 2 is a block diagram showing a collaboration screen apparatus of the function expandable collaboration screen system according to the present invention.

Referring to FIG. 2, the function expandable collaboration screen apparatus 100 according to the present invention includes a collaboration page unit 110, a content communication unit 120, a content conversion unit 130, an information storage unit 140, a connection authority management unit 150, and a web app management unit 160.

The collaboration page unit 110 includes one or more collaboration containers 111. Each collaboration container 111 may perform common functions required for collaboration. The collaboration page unit 110 receives collaboration content and collaboration content information from the collaboration client 200, generates the collaboration container 111, and shares the received collaboration content through the generated collaboration container 111. Most content in the collaboration container 111 may be shared, including, but not limited to, a user's local document or video in addition to web-based content.

The collaboration container 111 executes the received converted collaboration content. If the received converted collaboration content is an application, the collaboration container 111 executes the application and shares the executed application, allowing the collaboration work to be performed. The function expandable collaboration screen apparatus 100 according the present invention may share or control one or more collaboration containers 111 separately. Furthermore, the function expandable collaboration screen apparatus 100 may share or control the entire collaboration page unit 110.

If the received collaboration content is a document or video, the generated collaboration container 111 may be or include an application such as a document program or video player for replaying or showing the received converted collaboration content.

The collaboration container 111 may expand its functions by adding a web application. The web application (hereinafter, referred to as a web app) refers to an application that is reliant on a web browser and accessed by users over a network such as the Internet or an intranet. For example, if a web app for video call is added onto a shared screen, several users may perform collaboration work while making a video call with one another, thereby providing more efficient collaboration environment.

The collaboration page unit 110 delivers collaboration page unit information including a collaboration page update event to the collaboration client 200, allowing the content to be shared and allowing the collaboration work to be performed. The collaboration page unit information is information about collaboration content executed by the collaboration page unit of the collaboration screen apparatus 100, which may include an image screen of collaboration content under execution, expandable-web app information, and content change information.

The content communication unit 120 receives the collaboration content including web content, general content (picture, video, document, etc.), and web app, and information about the collaboration content from the one or more collaboration clients 200. The received collaboration content and collaboration content information for the collaboration work are delivered to the collaboration screen apparatus 100 through the content communication unit 120 for collaboration work. The content communication unit 120 delivers the received collaboration content to the content conversion unit 130. The collaboration content information may include information for restoring the collaboration content, uniform resource locator (URL) information, uniform resource identifier (URI) information, document object model information, and variable parameter information.

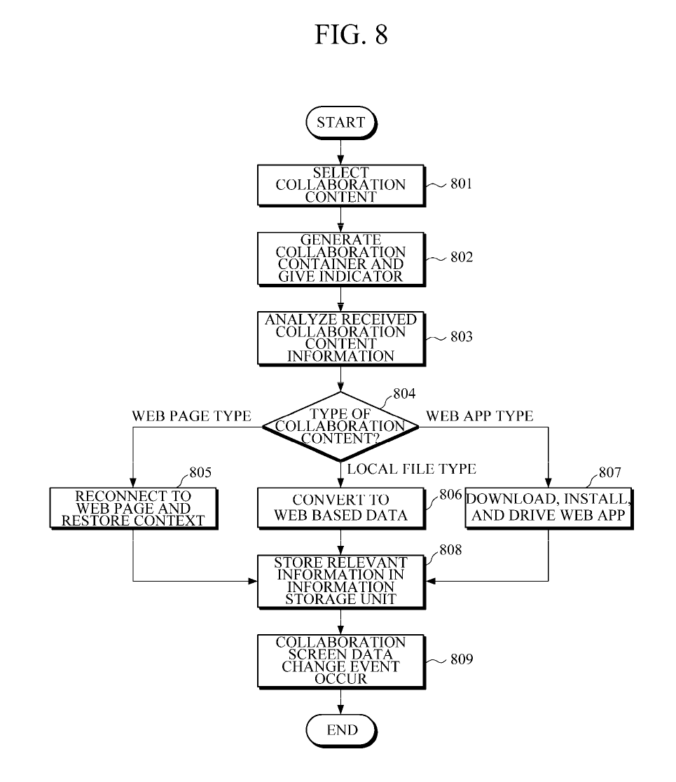

The content conversion unit 130 converts the collaboration content received from the content communication unit 120 such that the collaboration content may be used in collaboration work. The function expandable collaboration screen apparatus 100 according to the present invention may expand its functions by adding a web app during a collaboration content sharing process of the collaboration container 111 for the collaboration work. Accordingly, the content conversion unit 130 converts the collaboration content into data capable of being embedded in the collaboration container 111, on the basis of the type of the received collaboration content. That is, the content conversion unit 130 converts the received collaboration content such that the collaboration screen apparatus 100 may expand its functions by adding a web app. Also, the content conversion unit 130 delivers the converted collaboration content and the collaboration content information received form the content communication unit 120, to the information storage unit 140. The conversion process will be described below in detail with reference to FIG. 8.

The information storage unit 140 stores the converted collaboration content and the collaboration content information received from the content conversion unit 130. Also, the information storage unit 140 delivers the converted collaboration content received from the content conversion unit 130, to the collaboration page unit 110. Moreover, the information storage unit 140 receives and stores content and collaboration work details under execution in the collaboration page unit 110.

The connection authority management unit 150 manages remote control and connection authority of the collaboration clients 200 and gives the remote control and connection authority to the collaboration clients 200 which want collaboration work.

The web app management unit 160 includes a plurality of web apps and delivers a web app upon the reception of a request for the web app from the collaboration container 111 of the collaboration page unit 110.

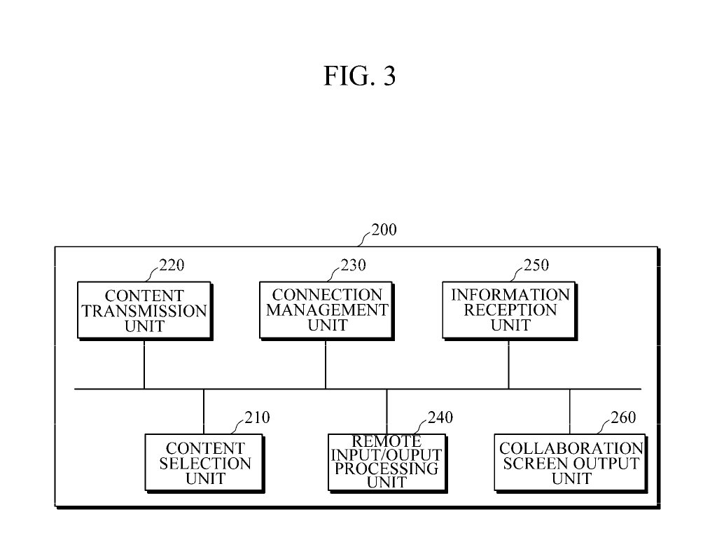

FIG. 3 is a block diagram showing a function expandable collaboration screen system according to the present invention.

Referring to FIG. 3, the collaboration client 200 according to the present invention includes a content selection unit 210, a content transmission unit 220, a connection management unit 230, a remote input/output processing unit 240, information reception unit 250, and a collaboration screen output unit 260.

The content selection unit 210 selects collaboration content for collaboration work and delivers the selected collaboration content in addition to information about the selected collaboration content to the collaboration screen apparatus 100 through the content transmission unit 220. The collaboration content information may include information about the purpose, object, and range of the collaboration. The collaboration client 200 performs collaboration work on the basis of the collaboration content and collaboration content information delivered to the collaboration screen apparatus 100.

The connection management unit 230 is in charge of connection between the collaboration screen apparatus 100 and the collaboration client 200. The collaboration screen apparatus 100 and the collaboration client 200 may be connected through a relay server such as the Internet network, or using a variety of communication methods such as local area network (LAN), NFC, and WiFi Direct.

The remote input/output processing unit 240 allows the collaboration clients 200 to connect to the collaboration page unit 110 of the collaboration screen apparatus 100 and perform remote control. The collaboration clients 200 connect to the collaboration screen apparatus 100 through the remote input/output processing unit 240 to share the collaboration content and perform collaboration work.

The information reception unit 250 receives from the collaboration screen apparatus 100 information about the collaboration content to be shared for the collaboration work. The collaboration content executed on the collaboration screen apparatus 100 is shared by the one or more collaboration clients 200 for the collaboration work. Accordingly, information about the collaboration content shared in the collaboration screen apparatus is collected. The information about the collaboration content may include shared collaboration content information, content editing authority, shared target, etc.

The collaboration screen output unit 260 performs restoration and display on the basis of the collaboration content information received from the collaboration screen apparatus 100. The collaboration content information received through the information reception unit 250 includes the shared collaboration content image information. The collaboration content image information may be provided by streaming image and video to directly transmit information about the image. Also, the collaboration content image information may be provided by analyzing data and starting the data on a display. For example, the information may be transmitted as an HTML document, and the browser may parse the HTML document to represent the image on the screen. The method of displaying the collaboration content image information is not limited to the above method and may include all other methods for displaying video on a screen. To perform collaboration work in the collaboration clients 200, the collaboration screen output unit 260 restores an image using the collaboration content image information and outputs the restored image to the screen.

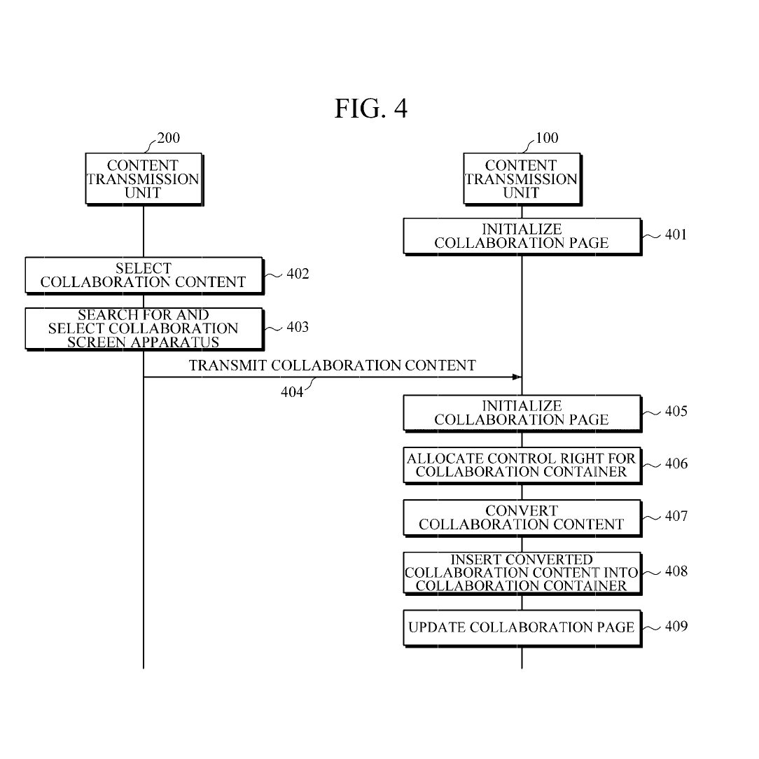

FIG. 4 is a flowchart illustrating a method of moving collaboration content of a function expandable collaboration screen system according to an embodiment of the present invention.

Referring to FIG. 4, in the method of moving collaboration content of a function expandable collaboration screen system according to the present invention, firstly, the collaboration screen apparatus 100 initializes a collaboration page unit to prepare for collaboration work in 401.

Next, the collaboration client 200 selects collaboration content to be shared for the collaboration work in 402. Then, the collaboration client 200 searches for collaboration screen apparatuses 100 and selects the collaboration screen apparatus 100 for performing collaboration work on the collaboration content among the searched collaboration screen apparatuses in 403. Next, the collaboration client 200 transmits the selected collaboration content to the collaboration screen apparatus 100 in 404.

Next, the collaboration screen apparatus 100 generates a collaboration container in 405. That is, the collaboration screen apparatus 100 generates the collaboration container for executing the collaboration content on the basis of the collaboration content received from the collaboration client 200 and sharing the executed collaboration content to perform collaboration work. Next, the collaboration screen apparatus 100 firstly allocates a control right for controlling the collaboration container to the collaboration client 200 that has transmitted the collaboration content in 406.

The collaboration screen apparatus 100 converts the received collaboration content such that the collaboration content may be inserted into the collaboration container in 407. The collaboration screen apparatus 100 may expand its functions by adding a web app to the collaboration content under execution in the collaboration container. Accordingly, the collaboration screen apparatus 100 converts the collaboration content received from the collaboration client 200 such that the collaboration content may be executed in the collaboration container. Next, the collaboration screen apparatus 100 inserts the converted collaboration content into the collaboration container in 408. Next, the collaboration screen apparatus 100 updates the collaboration page unit in 409.

The collaboration screen apparatus 100 may expand its functions by adding a web app to the collaboration content inserted into and executed in the collaboration container. The converted collaboration content under execution in the collaboration container may be embedded into a new web app. This may allow the new function to be added and allow the added function to be shared with the collaboration client.

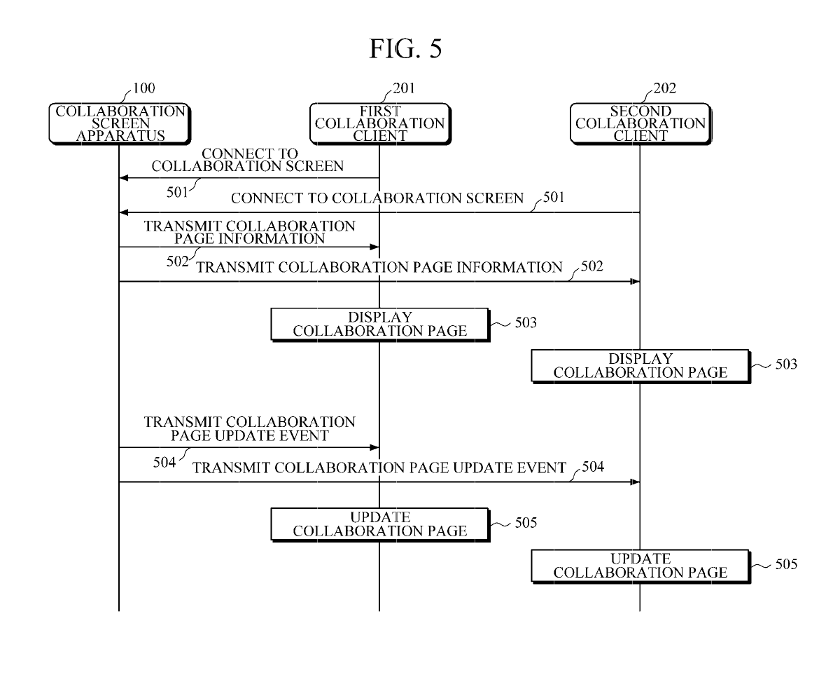

FIG. 5 is a flowchart illustrating a method of sharing collaboration content of a function expandable collaboration screen system according to an embodiment of the present invention.

Referring to FIG. 5, in the method of sharing collaboration content of a function expandable collaboration screen system according to the present invention, firstly, a first collaboration client 201 and a second collaboration client 202 connect to the collaboration screen apparatus 100 in 501. Specifically, the first collaboration client 201 and the second collaboration client 202 connect to the collaboration screen apparatus 100 for collaboration work when the collaboration screen apparatus 100 prepares for the collaboration page unit for sharing the collaboration content.

Next, the collaboration screen apparatus 100 transmits the collaboration page unit information to the first collaboration client 201 and the second collaboration client 202 in 502. The collaboration screen apparatus 100 transmits the collaboration page unit information to the connected first collaboration client 201 and second collaboration client 202. The collaboration page unit information is information about collaboration content executed by the collaboration page unit of the collaboration screen apparatus 100, which may include information required to restore the collaboration contend under execution, such as page URL, page attribute information, page DOM information, and a variety of variable parameter information. Also, if the content can not be restored, an image stream (image screen) may be transmitted. In this case, the collaboration screen apparatus 100 may perform an authentication procedure for qualification of sharing and collaboration on the first collaboration client 201 and the second collaboration client 202.

Next, the first collaboration client and the second collaboration client display the collaboration page unit when receiving the collaboration page unit information from the collaboration screen apparatus 100 in 503. The first collaboration client 201 and the second collaboration client 202 display on the screen the collaboration page including the collaboration content image on the basis of the received collaboration page unit information.

Next, the collaboration screen apparatus 100 transmits a collaboration page unit update event to the first collaboration client 201 and the second collaboration client 202 when a collaboration screen data change event occurs in 504. The collaboration screen data change event denotes all changes in collaboration content that is performed in the collaboration screen apparatus 100. As the first collaboration client 201 or the second collaboration client 202 share the collaboration content and perform collaboration work, a change in the collaboration content may occur. The collaboration screen apparatus 100 transmits the collaboration page update event including information about all the changes, to all collaboration clients sharing the collaboration content.

The first collaboration client 201 and the second collaboration client 202 update the collaboration page unit in 505. Specifically, the first collaboration client 201 and the second collaboration client 202 update a collaboration page unit, by applying the change according to the collaboration page update event received from the collaboration screen apparatus 100. In response to the updated collaboration page unit, a shared screen is updated.

Two collaboration clients for collaboration work, the first collaboration client and the second collaboration client, have been described in FIG. 5. However, the present invention should not be construed as limited to the number of collaboration clients. Accordingly, one or more collaboration clients may connect to the collaboration screen apparatus and perform collaboration work.

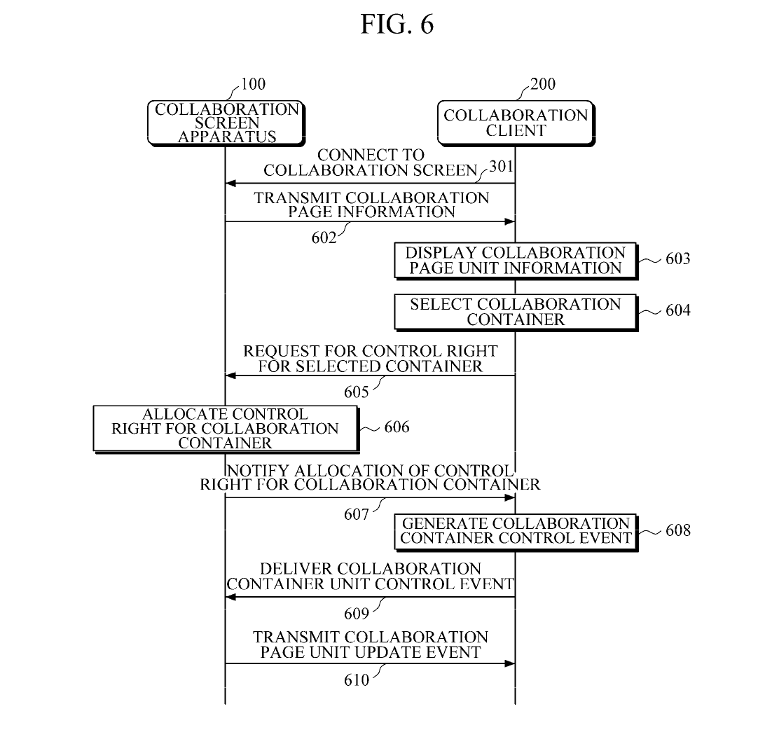

FIG. 6 is a flowchart illustrating a method of acquiring a control right for controlling collaboration content of a function expandable collaboration screen system according to an embodiment of the present invention.

Referring to FIG. 6, in the method of acquiring the control right for controlling collaboration content of a function expandable collaboration screen system according to the present invention, firstly, the collaboration client 200 connects to the collaboration screen apparatus 100 in 601. Next, the collaboration screen apparatus 100 transmits collaboration page unit information to the collaboration client 200 in 602. The collaboration page unit information is information about collaboration content executed by the collaboration page unit of the collaboration screen apparatus 100, which may include information required to restore the collaboration contend under execution, such as page URL, page attribute information, page DOM information, and a variety of variable parameter information. Also, if the content can not be restored, an image stream (image screen) may be transmitted.

Next, the collaboration client 200 displays a collaboration page on a screen on the basis of the received collaboration page information in 603. The collaboration client 200 receives collaboration page information from the collaboration screen apparatus 100 and then displays the collaboration page on the screen on the basis of the received collaboration page information.

Next, the collaboration client 200 selects a collaboration container in 604. The collaboration client 200 searches for collaboration containers of the collaboration screen apparatus 100 and selects a collaboration container for performing collaboration work among the searched collaboration containers.

Next, the collaboration client 200 requests a control right for controlling the selected collaboration container from the collaboration screen apparatus 100 in 605. In the collaboration screen system according to the present invention, the collaboration client 200 connects to the collaboration container of the collaboration screen apparatus 100 and then remotely controls the collaboration page unit, thus perform collaboration work. Accordingly, in order to perform collaboration work, a control authority for remotely controlling the collaboration page unit should be given to each collaboration client. The control-right request of the collaboration client 200 for the collaboration container may be performed automatically upon selection of the collaboration container or performed by further instructions.

Next, the collaboration screen apparatus 100 allocates the control authority for controlling the collaboration container when receiving the control authority request for the collaboration container from the collaboration client 200 in 606. The collaboration screen apparatus 100 may allocate the control right on the basis of predetermined or stored authority information of each collaboration client 200 or authority information of the collaboration container. Alternatively, the collaboration screen apparatus 100 may allocate the control right after checking the control authority of each collaboration client 200 through an ID and a password for identification. Next, the collaboration screen apparatus 100 notifies the collaboration client 200 that the control right for the collaboration container has been allocated in 607.

Next, the collaboration client 200 generates a collaboration container control event when receiving the control right for the collaboration container from the collaboration screen apparatus 100 in 608. The collaboration container control event includes a remote control instruction that is indicated to the collaboration container by the collaboration client 200. That is, the collaboration client 200 generates a control instruction for remotely controlling the collaboration content of the collaboration container. Next, the collaboration client 200 delivers the collaboration container control event to the collaboration screen apparatus 100 in 609.

When a collaboration screen data change event occurs due to the collaboration container control event, the collaboration screen apparatus 100 transmits the collaboration page update event to the collaboration client 200 in 610. The collaboration screen data change event denotes all changes in collaboration content that is performed in the collaboration screen apparatus 100. The collaboration screen apparatus 100 transmits the collaboration page update event including information about all the changes, to all collaboration clients 200 sharing the collaboration content.

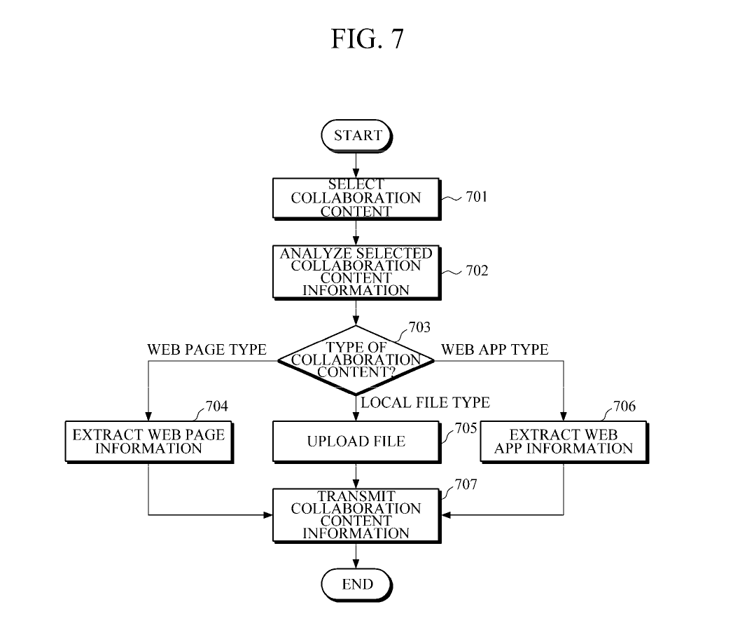

FIG. 7 is a flowchart illustrating a content transmission method for extracting of transmitting content, which enables information extraction depending on types of collaboration content according to an embodiment of the present invention.

Referring to FIG. 7, firstly, the content transmission method for extracting information on the basis of types of collaboration content according to an embodiment of the present invention selects collaboration content in 701. The method selects one from among stored two or more collaboration contents in order to perform the collaboration work with another user.

Next, the method analyzes information about the selected content in 702. The collaboration content may have a different type or form depending on its objective or function. Accordingly, the method analyzes the information about the selected content before classifying the type of the collaboration content. The information about the selected content may include information about the type, form, objective, and capacity of the content.

Next, the method classifies the type of the collaboration content in 703. The method identifies the type of the collaboration content on the basis of the information analysis result for the selected content. The collaboration content may be largely classified into three types. The first type is a web page, the second type is a general local file, and the third type is a web app such as a widget.

If the collaboration content is a web page, the method extracts web page information in 704. The web page collectively refers to web documents on the Internet, which may include an image, sound, and video as well as a text such as a general document. If the type of the collaboration content is a web page, the method extracts web page information. The web page information includes a uniform resource locator (URL), a size of an area, DOM information, etc. If the web page is web media including an image, sound, and video, the web page information may include additional information such as type information, playing time, and codec information of the image, sound, and video, which are required for signal decoding.

If the collaboration content is a local file, the method uploads the collaboration content to the collaboration screen apparatus or an external content server in 705. In this case, if additional encoding is required, the method issues a uniform resource identifier (URI) for connecting to the content after an encoding process and allows the URI to be shared with several users.

If the collaboration content is a web app, the method extracts web app information in 706. If the collaboration content is an app such as a widget executable at a client side, the method extracts the current execution status firstly, and then collects a URL or file of the widget to extract web app information.

Next, the method transmits collaboration content information according to the classified type of the collaboration content in 707. The method transmits to the collaboration screen apparatus collaboration content information including local files and information extracted from the web page or web app and shares the collaboration content with one or more clients to allow collaboration work to be performed.

FIG. 8 is a flowchart illustrating a method of receiving collaboration content according to an embodiment of the present invention.

Referring to FIG. 8, a method of receiving content according to an embodiment of the present invention receives collaboration content and collaboration content information from the collaboration client in 801. The method simultaneously receives the collaboration content and the collaboration content information from the collaboration client. The collaboration content denotes content itself, and the collaboration content information includes the type or form of the collaboration content and information extracted from the collaboration content. Next, the method generates a collaboration container and gives an identifier to the collaboration container in 802.

Next, the method analyzes received collaboration content information in 803. The method analyzes the received collaboration content information and classifies the type of the received collaboration content according to the analysis result in 804. The received collaboration content may be classified into a web page type, a local file type, and a web app type, as shown in FIG. 7.

If the collaboration content is a web page, the method reconnects to a web page and restores context in 805. If the collaboration content is a web page, the method reconnects to a web page through URL information and restores a relevant page using the received context information.

If the collaboration content is a local file, the method converts the collaboration content into web-based data in 806. If the collaboration content is a local file such as a file-based general document or video and image, the method transmits URI information acquired during the content transmission procedure, and thus converts the URI such that the URI may be embedded into the collaboration container and allows the URI to be loaded by the collaboration container.

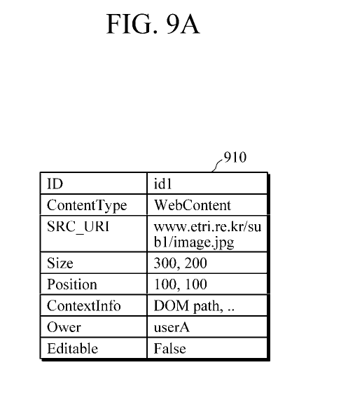

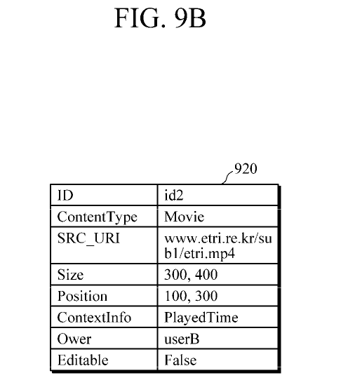

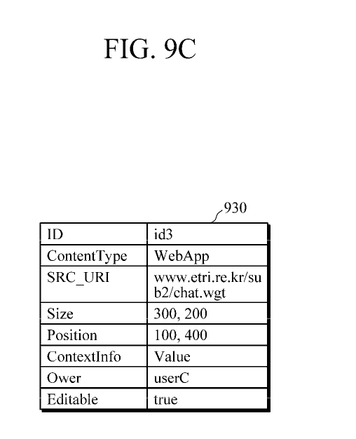

If the collaboration content is a web app, the method downloads, installs, and then drives the web app in 807. If the collaboration content is a web app or widget, the method downloads the app using the URL specified in the web app, installs the app in the collaboration screen unit, and drives the app. In this case, the method should convert the web app or widget such that the web app or widget may be embedded into the collaboration container. The method may generate an embeddable code with downloaded widget package (a collection of HTML, JS, and CSS as a config file having an extension of wgt) and add the embeddable code to the collaboration container. The embeddable code will be described below in details with reference to FIG. 9. In order to install and drive the web app, a run-time execution environment may be included and established separately in the collaboration screen apparatus.

Next, the method stores a variety of information used in the container, in the collaboration screen storage in 808. The method stores the collaboration content and the information generated according to collaboration content type in an information storage. The method generates a collaboration screen data change event to update the screen of the collaboration screen apparatus in 809.

FIG. 9a illustrates a configuration of collaboration content information of web-page-based content according to an embodiment of the present invention.

Referring to FIG. 9a, an information configuration of the web-page-based content 910 may be represented as a pair of a property and a corresponding value. Each content may have an identifier (ID) and specify its type. The information configuration may vary depending on the type of the content. General web-page-based content 910 may include lots of information required for web page restoration, such as the URL of the web page, the size of the selected area, a DOM path, and a variety of variable parameter information, and may include additional information such as owner information, possibility of edition, etc.

FIG. 9b illustrates a configuration of collaboration content information of local-file-based content according to an embodiment of the present invention.

Referring to FIG. 9b, the local-file-based content 920 may have an identifier (ID) and specify its type. The information configuration may vary depending on the type of the content. Furthermore, information required for restoration such as converted link information, size, play time point, etc. may be additionally described.

FIG. 9c illustrates a configuration of collaboration content information of a web app according to an embodiment of the present invention.

Referring to FIG. 9c, for a web app 930 an address and size of the packed web app and information required to restore the web app may be described. An embodiment of converting an information configuration of the web app 930 into an embeddable web app is illustrated in Table 1.

TABLE 1
A web app capable of being embedded.

```
<div class=’CollaborationContainer’
  id=’id3’
  type=’WebApp’
  src_uri=’www.etri2.re.kr/sub2/chat.wgt’
  width=’300px’ height=’200px’
  ownerId=’userC’ ... ></div>
```

As shown in Table 1, it may be utilized in configuration of collaboration screen that a collaboration container class is designated and represented as a user interface or a variety of property values are separately specified in a tag.

The function expandable collaboration screen system according to the present invention may expand its functions by dynamically adding required web apps to the screen according to the purpose of the collaboration when configuring the collaboration screen having a variety of contents, thereby establishing a new collaboration environment for providing a variety of web apps such as a video conference, schedule management, etc. as well as a simple document sharing and editing function provided by the existing web-board-based system. When the collaboration screen is locally established during operation of the collaboration screen, the collaboration screen may be usefully utilized even in a small-sized group requiring security.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A function expandable collaboration screen apparatus comprising:
a content conversion unit configured to classify received collaboration content on the basis of the type thereof and convert the received collaboration content such that a web application is inserted into the received collaboration content;
a web app management unit configured to store a plurality of web applications and delivers the stored web application upon a request; and
a collaboration page unit configured to execute the converted collaboration content to generate one or more collaboration containers that are shared with one or more other users, and add to the converted collaboration content the web application received from the web app management unit to expand functions thereof.

2. The function expandable collaboration screen apparatus of claim 1, further comprising:
a content communication unit configured to receive the collaboration content;
an information storage unit configured to store the converted collaboration content; and
a connection authority management unit configured to manage a remote control authority for the collaboration content and allocate a control right for the collaboration container.

3. The function expandable collaboration screen apparatus of claim 1, wherein the content conversion unit classifies the received collaboration content into a web page type, a local file type, and a web application type.

4. The function expandable collaboration screen apparatus of claim 1, wherein the collaboration container generated by the collaboration page unit includes a program or application for directly executing the collaboration content.

5. The function expandable collaboration screen apparatus of claim 1, wherein the collaboration page unit shares and controls the collaboration containers respectively or simultaneously.

6. The function expandable collaboration screen apparatus of claim 1, wherein the collaboration content includes at least one of a web page, a web application, and a local file including a document, a sound, and a video.

7. A function expandable collaboration screen system comprising:
a collaboration screen apparatus configured to generate a collaboration container on the basis of the received collaboration content and collaboration content information, allocate a control right for the collaboration container, convert the received collaboration content and insert the converted collaboration content into the collaboration container to perform sharing and collaboration works, and deliver a content change occurring in the collaboration content of the collaboration container; and
a collaboration client configured to select the collaboration content, deliver the selected collaboration content and the collaboration content information to the collaboration screen apparatus, remotely connect to the collaboration screen apparatus to remotely control the collaboration content, and update a screen on the basis of the received content change.

8. The function expandable collaboration screen system of claim 7, wherein the collaboration content information includes at least one of information required for collaboration content restoration, uniform resource locator (URL) information, uniform resource identifier (URI) information, document object model information, and variable parameter information.

9. The function expandable collaboration screen system of claim 7, wherein the collaboration screen apparatus expands functions thereof by adding a web application to the converted collaboration content.

10. A content collaboration method of a function expandable collaboration screen system including a collaboration screen apparatus configured to execute and share collaboration content and one or more collaboration clients configured to remotely control the collaboration screen apparatus, the method comprising:
selecting collaboration content for performing collaboration work;
searching for and selecting a collaboration screen apparatus for sharing the collaboration content;
transmitting the collaboration content and collaboration content information to the selected collaboration screen apparatus, depending on a result;
generating a collaboration container for sharing the collaboration content;
converting the collaboration content to insert the converted collaboration content into the collaboration container; and
sharing the collaboration container including the converted collaboration content with the one or more collaboration clients.

11. The method of claim 10, wherein the selecting comprises:
analyzing information about the selected collaboration content;
classifying a type of the collaboration content on the basis of the analyzed collaboration content information; and
generating the collaboration content information on the basis of the type classification to transmit the collaboration content information to the collaboration screen apparatus.

12. The method of claim 11, wherein the collaboration content is classified into at least one of a web page type, a local file type, and a web application type.

13. The method of claim 11, wherein if the collaboration content is a web page, the collaboration content information includes web page information for restoring the web page, if the collaboration content is a local file, the collaboration content information includes information for uploading the local file to the collaboration screen apparatus, if the collaboration content is a web app, the collaboration content information includes information for extracting the current execution status.

14. The method of claim 10, wherein the collaboration content information includes at least one of information required for collaboration content restoration, uniform resource locator (URL) information, uniform resource identifier (URI) information, document object model information, and variable parameter information.

15. The method of claim 10, wherein the converting comprises:
analyzing the received collaboration content information to classify a type of the collaboration content; and
converting the collaboration content on the basis of the type classification.

16. The method of claim 15, further comprising, if the collaboration content is a web page, connecting to the web page through uniform resource locator (URL) information included in the collaboration content information and restoring the web page through context information included in the collaboration content information.

17. The method of claim 15, further comprising, if the collaboration content is a local file including a document, a video, and an image, converting the uniform resource identifier (URI) information included in the collaboration content information such that the URI information may be embedded into the collaboration container to allow the local file to be read from the collaboration container.

18. The method of claim 15, further comprising, if the collaboration content is a web application, downloading the web application on the basis of the URL of the web application included in the collaboration content information, installing the web application in the collaboration container, and driving the web application.

19. The method of claim 10, further comprising expanding functions by adding a web application to the converted collaboration content.

20. The method of claim 10, further comprising generating the collaboration container and giving an indicator to the generated collaboration container.
